(19) United States
(12) Patent Application Publication
(10) Pub. No.: US 2010/0148002 A1
(43) Pub. Date: Jun. 17, 2010

(54) Configurable Cockpit System Based On Design Parameters

(76) Inventors: Young-Keun Park, Seo-gu (KR); Cheong-Young Kim, Cheongju-si (KR); Moon-Yeol Kim, Yuseong-gu (KR); Sung-Lae Kim, Seo-gu (KR); Tae-Kyu Reu, Gunpo-si (KR); Dae-Yearl Lee, Seo-gu (KR)

Correspondence Address: CAHN & SAMUELS LLP, 1100 17th STREET NW, SUITE 401, WASHINGTON, DC, 20036, US

(21) Appl. No.: 12/334,525

(22) Filed: Dec. 15, 2008

(51) Int. Cl. B64D 11/00; G06F 17/50; G06G 7/48; G06N 5/02

(52) U.S. Cl. 244/118.5; 703/1; 703/8; 706/46

(57) ABSTRACT

Disclosed is a configurable cockpit system based on design parameters, which comprises: a configurable cockpit which has an interface between a user and the cockpit, and various sub-systems for efficiently measuring design parameters; an interface for synchronizing configuration which converts the design parameters measured in the configurable cockpit to the cockpit design parameters for the CAD system, or converts the cockpit design parameters of the CAD system to the design parameters of the configurable cockpit; and cockpit design parameter database which accumulates cockpit design parameters and automatically modifies the CAD 3D configuration through automatic linking to the cockpit configuration template based on the cockpit design parameters.

### TECHNICAL FIELD

The present invention relates to a configurable cockpit system and, more specifically, to a configurable cockpit system based on design parameters for designing cockpit, wherein the modified configuration is automatically linked and synchronized according to the digital configuration of the CAD system and linked parameter information. The present invention also relates to a method for setting the system environment of the configurable cockpit system.

### Prior Arts

Modern large-scale complex weapons systems like jet fighter continue to become more complicated, high-technology based and highly precise as current technologies rapidly advance. Also demanded by the market are shortened developing time over the whole lifetime period of the airplane, reduction of cost and increased performance.

In order to cope with these trends, it is necessary to catch market demands at early stage of development and maximize efficiency of developing weapons system. For this, it is required to develop various methods, technique and supporting tools that can efficiently perform system design and analysis, and shape design.

For meeting the need of the industry, applying M&S (Modeling & Simulation) has been proposed, and recently integrated development of airplane adopting VR (Virtual Reality) technique has been under development in countries having advanced aircraft industry.

VR is a computer-aided system of virtual environment where users can feel and act as if they were in actual environment.

In order to support digital-based 3D R&D modeling and simulation (M&S) environment, integrated virtual development environment and technology that can efficiently support over the whole period of R&D is required, and various virtual mockup and virtual trial system should be developed based on the conventional computerized digital mockup technology so that designers and users can perform a design, review and test the system under the integrated modeling and simulation environment similar to the actual airplane environment. In the development of an airplane, especially in designing the cockpit, consideration should be made so that interface between the pilot and airplane continually exists, which has a crucial effect on the safety of the airplane. Therefore, the convenience of manipulation and safety should be confirmed in the design stage of airplane.

### DISCLOSURE

The present invention is a part of the technical field of computerized digital mockup, and relates to a virtual mockup and virtual trial technology which support integrated virtual development environment and technology in order to support digital-based 3D R&D modeling and simulation environment of weapons system.

Conventional computerized digital mockup method has been applied visualizing 3D shape in the computer, interference and customizing of parts, and algorithm and technology appropriate for design and review. However, there has not been known on the development of technology on the configurable cockpit system adopting integrated virtual development environment and cockpit system design to apply ergonomic and virtual reality technology.

Therefore, the present invention has been designed to provide a configurable cockpit system based on design parameters for the design of a new and high-tech weapons system considering design demands of users and ergonomic user interface.

The object of the present invention is to provide an integrated development environment for the design and analysis in the process of weapons system development. One feature of the present invention is that modified configuration is automatically linked and synchronized according to the digital configuration and linked parameter information of the CAD system.

According to one aspect of the present invention, provided is a configurable cockpit system based on design parameters which comprises a configurable cockpit which has an interface between a user and the cockpit, and various sub-systems for efficiently measuring design parameters; an interface for synchronizing configuration which converts the design parameters measured in the configurable cockpit to the cockpit design parameters for the CAD system, or converts the cockpit design parameters of the CAD system to the design parameters of the configurable cockpit; and cockpit design parameter database which accumulates cockpit design parameters and automatically modifies the CAD 3D configuration through automatic linking to the cockpit configuration template based on the cockpit design parameters.

According to another aspect of the present invention, provided is a method for configuring the environment of a configurable cockpit based on design parameters, comprising the steps of: manipulating various manipulators of the instruments in the cockpit by a user; calculating arrangement data of the various instruments according to the data resulting from the manipulation; setting the desired configuration of the configurable cockpit based on the calculated data; displaying various design parameters on the numeric display according to the set configuration; when the design parameters meet the needs of the user for the cockpit configuration, converting the design parameters to cockpit design parameters appropriate for the CAD system environment through the interface and algorithm for synchronizing configuration; when the design parameters do not meet the needs of the user for the cockpit configuration, resetting the manipulator of the corresponding instrument of the configurable cockpit; automatically linking the converted cockpit design parameters to the cockpit configuration template; and automatically generating the CAD 3D cockpit configuration according to the link and displaying the CAD system as a modified configuration.

### BRIEF DESCRIPTION OF DRAWINGS

FIG. 1 illustrates the construction of the configurable cockpit system based on design parameters of the present invention.

FIG. 2 is a detailed view of the configurable cockpit system of the present invention.

FIG. 3 is a flow diagram of the method of setting environment of the configurable cockpit system of the present invention.

FIG. 4 illustrates in detail the synchronization algorithm of configuration adopted by the configurable cockpit system of the present invention.

FIG. 5 illustrates the automatic linking of cockpit configuration template to the cockpit design parameters in the configurable cockpit system of the present invention.

### PREFERRED EMBODIMENT OF THE INVENTION

The present invention will now be described with reference to the attached drawings.

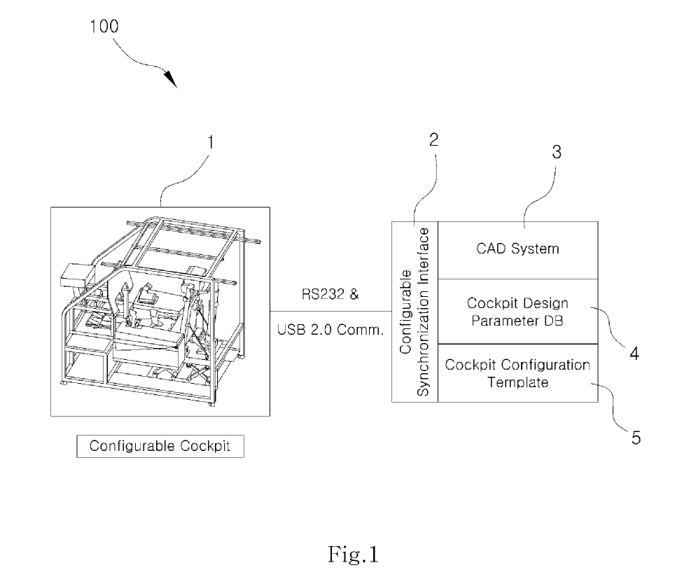

FIG. 1 illustrates the construction of the configurable cockpit system 100 based on design parameters of the present invention, which comprises a configurable cockpit 1, an interface for synchronizing configuration 2, cockpit design parameter database 4 and a cockpit configuration template 5.

And the configurable cockpit 1 and an interface for synchronizing configuration 2 are connected through RS 232 and USB 2.0.

The configurable cockpit 1 is designed so that the cockpit design parameters are variably configurable appropriate for the ergonomic environment and personal need of the pilot, and has an interface between a user and the cockpit, and various sub-systems for efficiently measuring design parameters. The interface for synchronizing configuration 2 converts the design parameters measured in the configurable cockpit 1 to the cockpit design parameters for the CAD system 3, or converts the cockpit design parameters of the CAD system 3 to the design parameters of the configurable cockpit 1.

The cockpit design parameter database 4 accumulates cockpit design parameters and automatically modifies the CAD 3D configuration through automatic linking to the cockpit configuration template based on the cockpit design parameters. The cockpit configuration template 5 is a template representing basic structure of the cockpit configuration.

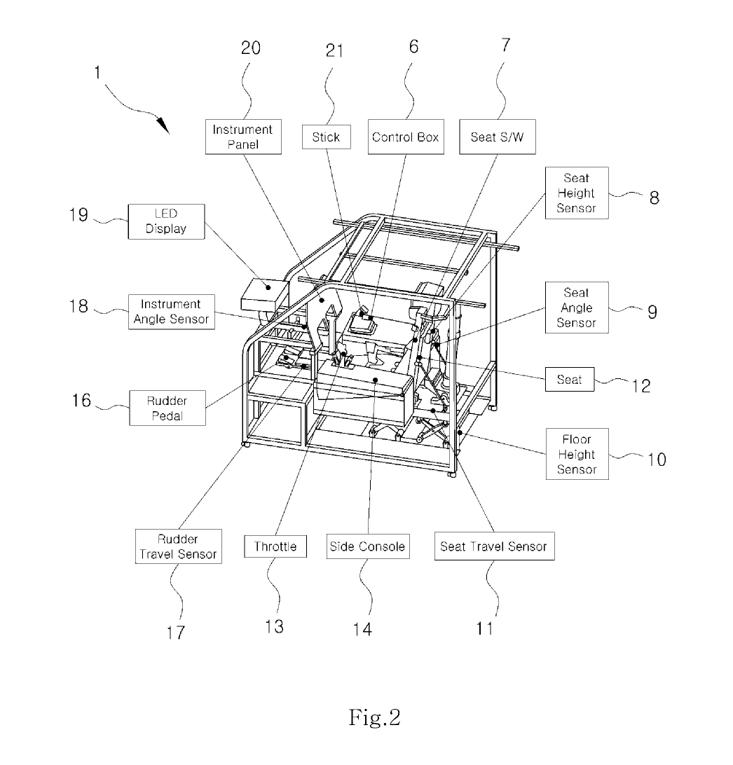

FIG. 2 is a detailed view of the configurable cockpit system 100 of the present invention, and is constructed as follows.

The cockpit (cabin) 1 is designed to provide the pilot with an environment identical with the actual cockpit, and includes various sub-systems which is a manipulating element including seat which is a manipulating element, instrument panel, side console and other major manipulators such as stick, throttle and rudder pedal. The cockpit also includes four LVDT (Linear Variable Differential) sensors and RVDT (Rotary Variable Differential) sensors, and numeric display for displaying measured values.

Now, only important parts of FIG. 2 will be described in the specification but remaining parts can easily recognized by those skilled in the art.

The seat 12 is designed so that the height of the seat, distance between seats and the angle of a backrest of the seat are adjustable in order to set the cockpit configuration suitable for the simulation of other plane cockpits or for the preference of a pilot. Also, the instrument panel, installed on the upper portion of the seat, is designed so that the angle of the dashboard is adjustable, and is replaceable depending on characteristics of the plane. The adjusted values are reflected in the design data through RS232 communication.

The side console 14 is designed so that the angles of the longitudinal and transverse axes of the right and left side consoles are adjustable, and is equipped with a rack to which various panels can be mounted.

The stick 21 which performs the function of a control stick, one of manipulating instruments of the cockpit, is installed on the right side console 13, makes it possible to evaluate the handling convenience for a pilot and manipulating performance, and provides USB and Serial port interface for performance and integrated simulation of the instruments.

The rudder pedal (not illustrated) is installed on the floor of the cockpit as one of the major manipulating instruments of the cockpit, which can be ergonomically adjusted in its location and the adjusted value is reflected in the design parameters through RS 232 communication, and provides USB and Serial port interface for performance and integrated simulation of the instruments.

The throttle 13 is installed on the left side console as one of the major manipulating instruments of the cockpit, makes it possible to evaluate the handling convenience for a pilot and manipulating performance, and provides USB and Serial port interface for performance and integrated simulation of the instruments.

In addition, main dashboard 20, control box 6, seat switch 7, seat height sensor 8, seat angle sensor 9, floor height sensor 10, seat travel sensor 11, calibrator of seat angle 15, rudder travel sensor 17, instrument angle sensor 18 and numeric display 19.

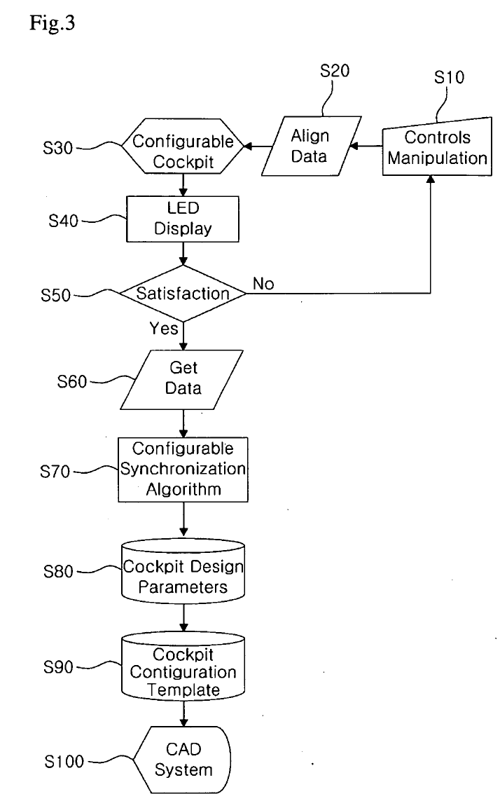

FIG. 3 is a flow diagram of the method of setting environment of the configurable cockpit system of the present invention. First in step S10, data is input through operation such as adjusting the angle by the seat angle adjusting dashboard. Then in step S20, data is arranged and in step S30 and S40, visualization is performed in the configurable cockpit 1 through the numeric display according to the input data. In step 50, when the conditions are satisfied, measured data is read into CAD database in step S60, and when the conditions are not satisfied in the step 50, the process returns to S10.

In step 70, conversion to the algorithm for synchronizing the configuration is performed, and in step 80, cockpit design parameters are configured. Then in step S90, cockpit configuration is automatically generated according to the input configuration. In step 100, the cockpit configuration is automatically expressed by CAD system.

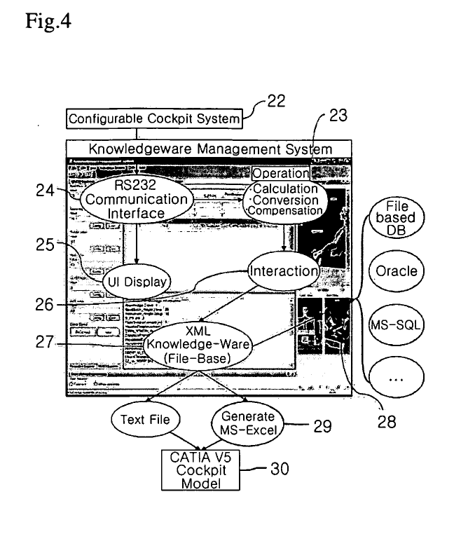

FIG. 4 illustrates in detail the synchronization algorithm of configuration. The configurable cockpit system 22 sets the parameters of the configurable cockpit by the user, and the processing part 23 performs a correction and conversion of the parameter. RS 232 communication interface 24 receives parameter data via RS 232 and USB communication. The UI display 25 provides a displaying window for user interface, and user can input and choose the needed information in the interaction 26. Processed values are stored in XML (eXtended Markup Language) 27 file format which is a neutral file format that can be stored in other database file formats such as Oracle or MS-SQL. The storing part 29 stores the cockpit parameter value as a text file or an excel file. The CATIA V5 cockpit model (30) is a CAD model automatically generated through the cockpit configuration template.

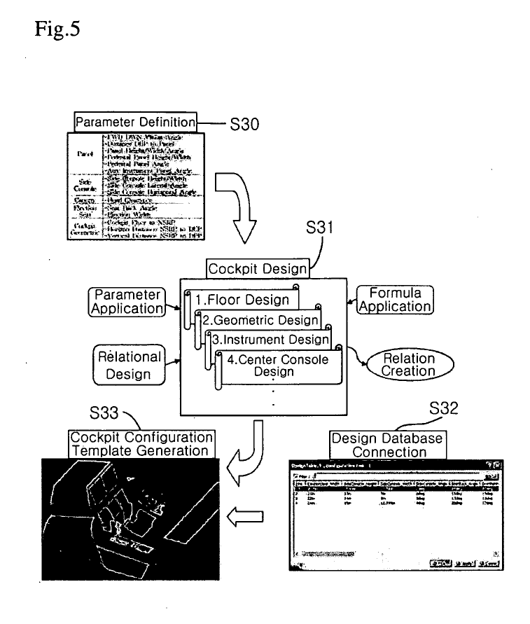

FIG. 5 illustrates the automatic linking of cockpit configuration template to the cockpit design parameters. In step S30, various cockpit design parameters such as adjusted seat angle and dashboard angle are identified. In step S31, cockpit configuration is designed by providing parameters such as floor design, geometry design and central console design, applying related design, providing formula and generating relation. In step S32, design database such as CAD system is linked, and in step S33, cockpit configuration template is generated by CAD system.

Now the operation of the present invention will be described with reference to the above drawings.

First, the an interface for synchronizing configuration 2 of FIG. 1 converts the various design parameters measured in the configurable cockpit system 100 of FIG. 1 (listed in table 1) to the cockpit design parameters of CAD system 3 of FIG. 1 through RS 232 communication. This conversion is carried out by the algorithm for synchronizing configuration, which is stored in the interface for synchronizing configuration 92.

TABLE 1

| Design Parameter | Controlling Method |
|---|---|
| Viewing Distance | Electrically driven |
| Seat backrest Angle | Electrically driven |
| Instrument Panel Angle | Electrically driven |
| Rudder Pedal Travel | Electrically driven |
| Floor Step | Electrically driven |
| Seat Travel (Up/Down) | Electrically driven |
| Side Console Horizontal Angle | Manually controlled |

This algorithm is provided through RS 232 communication and performs a calculation processing such as unit conversion, calculation of numeric equations and correction. The processed data is stored with XML (eXtended Markup Language) file, which is a neutral file format, in order to be applicable to the design database. Then the cockpit design parameter database 4 which accumulates cockpit design parameters is automatically linked to the cockpit configuration template 5 based on the cockpit design parameters and stores the 3D configuration form XML data to Microsoft Excel. The stored data reflects the cockpit configuration through design table of the CAD system. In generating the cockpit configuration, configuration change is automatically generated as a modified configuration according to the applied data values since the template is produced by applying Knowledge Based Design based on the concept of formula and relational design.

Therefore, in the configurable cockpit system of the present invention, a user manipulates various manipulators of the instruments shown in FIG. 2 in the cockpit 1, arrangement data of the various instruments is calculated according to the data resulting from the manipulation (step S20 in FIG. 3), and desired configuration of the configurable cockpit is set based on the calculated data.

The set configuration of the cockpit is displayed on the numeric display as in the step S40 of FIG. 3, and when the set cockpit configuration meets the needs of the user for the cockpit configuration (step S50 in FIG. 3), the measured data of step S60 of FIG. 3 is converted to cockpit design parameters appropriate for the CAD system environment (step S80 in FIG. 3) through the interface and algorithm for synchronizing configuration (step S70 in FIG. 3), shown in FIG. 4.

However, when the set cockpit configuration does not meet the needs of the user for the cockpit configuration, the process for generating configuration data (step S60 in FIG. 3) which is appropriate in ergonomic aspect is performed repeatedly by resetting the manipulator of the corresponding instrument of the configurable cockpit system 100 (step S 10 in FIG. 3). The converted cockpit design parameters are automatically linked to the cockpit configuration template of FIG. 5 (step S90 in FIG. 3) and the CAD 3D cockpit configuration is automatically generated and displayed on the CAD system as a modified configuration (step S10 in FIG. 3).

The cockpit configuration template and the values of the design parameters modified by the user using the CAD system is applied as a modified configuration in connection with the configurable cockpit system 100 through the interface and algorithm for synchronizing configuration.

In this way the configurable cockpit system based on design parameters of the present invention is operated.

Although the present invention has been described with respect to one embodiment, the invention is not limited to the example, and it should be acknowledged that any modification by those skilled in the art that does not change the idea of the present invention is within the scope of the present invention.

### INDUSTRIAL APPLICABILITY

In the configurable cockpit system based on design parameters of the present invention, the cockpit configuration template and the values of the design parameters modified by the user using the CAD system can be applied as a modified configuration in connection with the configurable cockpit system through the interface for synchronizing configuration.

By using the cockpit system of the present invention, the result of design process under digitalized virtual development environment can be clearly reviewed and confirmed in advance, and quickly reflected to the R&D and design of the plane thereby lowering the chance of design change, and ultimately reducing development cost and time.

What is claimed is:

1. A configurable cockpit system based on design parameters, which comprises:
a configurable cockpit which has an interface between a user and the cockpit, and various sub-systems for efficiently measuring design parameters;
an interface for synchronizing configuration which converts the design parameters measured in the configurable cockpit to the cockpit design parameters for the CAD system, or converts the cockpit design parameters of the CAD system to the design parameters of the configurable cockpit; and
cockpit design parameter database which accumulates cockpit design parameters and automatically modifies the CAD 3D configuration through automatic linking to the cockpit configuration template based on the cockpit design parameters.

2. The configurable cockpit system of claim 1, wherein RS 232 and USB 2.0 are used for communication between the configurable cockpit and the interface for synchronizing configuration.

3. The configurable cockpit system of claim 1, wherein the configurable cockpit comprises:
a seat wherein the height of the seat, distance between seats and the angle of a backrest of the seat are adjustable in order to set the cockpit configuration suitable for the simulation of other plane cockpits or for the preference of a pilot, and the adjusted values are reflected in the design data through RS232 communication;
an instrument panel which is designed so that the angle of the dashboard installed on the upper portion of the seat is adjustable, and is replaceable depending on characteristics of the plane, the measured value being reflected in the design data through RS232 communication;
a side console which is designed so that the angles of the longitudinal and transverse axes of the right and left side consoles are adjustable, and equipped with a rack so that various panels can be mounted;
a stick installed on the right side console, which performs the function of a control stick, one of manipulating instruments of the cockpit, makes it possible to evaluate the handling convenience for a pilot and manipulating performance, and provides USB and Serial port interface for performance and integrated simulation of the instruments;
a rudder pedal installed on the floor of the cockpit as one of the major manipulating instruments of the cockpit, which can be ergonomically adjusted in its location and the adjusted value is reflected in the design parameters through RS 232 communication, and provides USB and Serial port interface for performance and integrated simulation of the instruments; and
a throttle installed on the left side console as one of the major manipulating instruments of the cockpit, which makes it possible to evaluate the handling convenience for a pilot and manipulating performance and provides USB and Serial port interface for performance and integrated simulation of the instruments.

4. A method for configuring the environment of a configurable cockpit based on design parameters, comprising the steps of:
manipulating various manipulators of the instruments in the cockpit by a user;
calculating arrangement data of the various instruments according to the data resulting from the manipulation;
setting the desired configuration of the configurable cockpit based on the calculated data;
displaying various design parameters on the numeric display according to the set configuration;
when the design parameters meet the needs of the user for the cockpit configuration, converting the design parameters to cockpit design parameters appropriate for the CAD system environment through the interface and algorithm for synchronizing configuration;
when the design parameters do not meet the needs of the user for the cockpit configuration, resetting the manipulator of the corresponding instrument of the configurable cockpit;
automatically linking the converted cockpit design parameters to the cockpit configuration template; and
automatically generating the CAD 3D cockpit configuration according to the link and displaying the CAD system as a modified configuration.

5. The method for configuring the environment of a configurable cockpit of claim 4, further comprising the step of applying the value of the cockpit configuration template and design parameters which are modified by the designer using a CAD system as a modified configuration in connection with the configurable cockpit through the interface and algorithm for synchronizing configuration.

6. The method for configuring the environment of a configurable cockpit of claim 4, wherein the design parameters include viewing distance, angle of the backrest of the seat, instrument panel angle, rudder pedal travel, floor step, seat travel(up/down), side console and horizontal angle.

7. The method for configuring the environment of a configurable cockpit of claim 5, wherein the design parameters include viewing distance, angle of the backrest of the seat, instrument panel angle, rudder pedal travel, floor step, seat travel(up/down), side console and horizontal angle.

8. The method for configuring the environment of a configurable cockpit of claim 4, wherein, in generating the cockpit configuration, configuration change is automatically generated as a modified configuration according to the applied data values by the template which is produced by applying Knowledge Based Design based on the concept of formula and relational design.
